(19) United States
(12) Patent Application Publication
(10) Pub. No.: US 2011/0077348 A1
(43) Pub. Date: Mar. 31, 2011

(54) SEALANT COMPOSITION

(75) Inventors: Bedri Erdem, Midland, MI (US); Li Zhang, Franklin Park, NJ (US); Debkumar Bhattacharjee, Lake Jackson, TX (US); YI Jin, Lake Jackson, TX (US)

(73) Assignee: Dow Global Technologies Inc., Midland, MI (US)

(21) Appl. No.: 12/995,532

(22) PCT Filed: Jun. 2, 2009
(86) PCT No.: PCT/US09/45896

§ 371 Date: Dec. 1, 2010

Related U.S. Application Data
(60) Provisional application No. 61/058,320, filed on Jun. 3, 2008.

(51) Int. Cl. C08L 75/04

(52) U.S. Cl. 524/539; 525/458

(57) ABSTRACT

The instant invention is a sealant composition comprising an ultra-high solid polyurethane dispersion. The ultra-high solid polyurethane dispersion comprises (1) a first component comprising a first polyurethane prepolymer comprising the re-action product of a natural oil based polyol and polyisocyanate, (2) a second component comprising a media phase selected from the group consisting of a second polyurethane prepolymer emulsion, a low solid content polyurethane dispersion, a seed latex, and combinations thereof; and (3) optionally a chain extender. The ultra-high solid polyurethane dispersion has at least a solid content of at least 60 percent by weight of solid content, based on the total weight of the ultra-high solid polyurethane dispersion, and a viscosity of less than 5000 cps at 20 rpm at 21° C. using spindle #4 with Brookfield viscometer.

### CROSS-REFERENCE TO RELATED APPLICATIONS

This application is a non-provisional application claiming priority from the U.S. Provisional Patent Application No. 61/058,320 filed on Jun. 3, 2008, entitled “SEALANT COMPOSITION,” the teachings of which are incorporated by reference herein, as if reproduced in full hereinbelow.

### FIELD OF INVENTION

The instant invention relates to a sealant composition.

### BACKGROUND OF THE INVENTION

Inability to produce aqueous polyurethane dispersions with ultra-high solid contents prevents their performance in many different applications such as sealant applications. Aqueous polyurethane dispersions with low solid contents result in unacceptable levels of shrinkage upon drying, inability to incorporate higher levels of fillers into final sealant compositions, and requiring longer times to dry. In addition, ultra-high solid content polyurethane dispersions facilitate lower shipping and storage costs and production reduction time per unit volume of materials.

Despite the research efforts in developing ultra-high solid content polyurethane dispersions for different application, there is still a need for ultra-high solid content polyurethane dispersions suitable for sealant applications that provide reduced shrinkage upon drying, facilitate loading of additional fillers, and requiring relatively lesser amounts of time to dry. In addition, there is a need to produce sealant composition polyols from renewable sources such natural oil based polyols with enhanced properties.

### SUMMARY OF THE INVENTION

The instant invention is a sealant composition comprising an ultra-high solid polyurethane dispersion. The ultra-high solid polyurethane dispersion comprises (1) a first component comprising a first polyurethane prepolymer comprising the reaction product of a natural oil based polyol and polyisocyanate, (2) a second component comprising a media phase selected from the group consisting of a second polyurethane prepolymer emulsion, a low solid content polyurethane dispersion, a seed latex, and combinations thereof; and (3) optionally a chain extender. The ultra-high solid polyurethane dispersion has at least a solid content of at least 60 percent by weight of solid content, based on the total weight of the ultra-high solid polyurethane dispersion, and a viscosity of less than 5000 cps at 20 rpm at 21° C. using spindle #4 with Brookfield viscometer. The sealant composition may further include optionally one or more surfactants, optionally one or more dispersants, optionally one or more thickeners, optionally one or more pigments, optionally one or more fillers, optionally one or more freeze-thaw agent, optionally one or more neutralizing agents, optionally one or more plasticizers, and/or combinations thereof.

In one embodiment, the instant invention provides a sealant comprising an ultra-high solid polyurethane dispersion comprising (a) a first component comprising a first polyurethane prepolymer comprising the reaction product of a natural oil based polyol and polyisocyanate; (b) a second component comprising a media phase selected from the group consisting of a second polyurethane prepolymer emulsion, a low solid content polyurethane dispersion, a seed latex, and combinations thereof; and (c) optionally a chain extender; wherein the ultra-high solid polyurethane dispersion has at least a solid content of 60 percent or greater by weight of solid content, based on the total weight of said ultra-high solid polyurethane dispersion, and a viscosity of less than 5000 cps at 20 rpm at 21° C. using spindle #4 with Brookfield viscometer.

In an alternative embodiment, the instant invention provides a composition, in accordance with any of the preceding embodiments, except that the sealant composition further comprises one or more surfactants, one or more dispersants, one or more thickeners, one or more pigments, one or more fillers, one or more freeze-thaw agent, one or more neutralizing agents, one or more plasticizers, one or more antioxidants, one or more UV stabilizers, and/or combinations thereof. In an alternative embodiment, the instant invention provides a composition, in accordance with any of the preceding embodiments, except that the sealant composition comprises 25 to less than 100 percent by weight of said ultra-high solid polyurethane dispersion, based on the weight of the sealant composition.

In an alternative embodiment, the instant invention provides a composition, in accordance with any of the preceding embodiments, except that the sealant composition comprising 0.1 to 5 percent by weight of said one or more surfactants.

In an alternative embodiment, the instant invention provides a composition, in accordance with any of the preceding embodiments, except that the sealant composition comprises 0.1 to 5 percent by weight of said one or more dispersants.

In an alternative embodiment, the instant invention provides a composition, in accordance with any of the preceding embodiments, except that the sealant composition comprises 0.1 to 5 percent by weight of said one or more thickeners.

In an alternative embodiment, the instant invention provides a composition, in accordance with any of the preceding embodiments, except that the sealant composition comprises 0 to less than 10 percent by weight of said one or more pigments.

In an alternative embodiment, the instant invention provides a composition, in accordance with any of the preceding embodiments, except that the sealant composition comprising 0 to 75 percent by weight of said one or more fillers.

In an alternative embodiment, the instant invention provides a composition, in accordance with any of the preceding embodiments, except that the sealant composition comprises 0.1 to 2 percent by weight of said one or more freeze-thaw agents.

In an alternative embodiment, the instant invention provides a composition, in accordance with any of the preceding embodiments, except that the sealant composition comprises 0.1 to 1 percent by weight of said one or more neutralizing agents.

In an alternative embodiment, the instant invention provides a composition, in accordance with any of the preceding embodiments, except that the sealant composition comprises 0 to 12 percent by weight of said one or more plasticizers.

In an alternative embodiment, the instant invention provides a composition, in accordance with any of the preceding embodiments, except that the sealant composition further comprising 0.1 to less than 10 percent by weight of one or more pigments, and wherein said sealant composition has an elongation flexibility of at least 650 percent at −25° C.

In an alternative embodiment, the instant invention provides a composition, in accordance with any of the preceding embodiments, except that the sealant composition is substantially free of any pigments, and wherein said sealant composition has an elongation flexibility in the range of 100 to 600 percent at −25° C.

In an alternative embodiment, the instant invention provides a composition, in accordance with any of the preceding embodiments, except that the sealant composition is substantially free of any pigments, and wherein said sealant composition has an elongation flexibility in the range of 300 to 500 percent at −25° C.

In an alternative embodiment, the instant invention provides a composition, in accordance with any of the preceding embodiments, except that the sealant composition is substantially free of any pigments, and wherein said sealant composition has an elongation flexibility in the range of 200 to 2000 percent at 25° C.

In an alternative embodiment, the instant invention provides a composition, in accordance with any of the preceding embodiments, except that the sealant composition is substantially free /of any pigments, and wherein said sealant composition has an elongation flexibility in the range of 800 to 1200 percent at 25° C.

In an alternative embodiment, the instant invention provides a composition, in accordance with any of the preceding embodiments, except that the sealant composition has an elastic recovery of 50 percent or greater at −25° C.

In an alternative embodiment, the instant invention provides a composition, in accordance with any of the preceding embodiments, except that the sealant composition has an elastic recovery in the range of 60 to 80 percent or greater at −25° C.

In an alternative embodiment, the instant invention provides a composition, in accordance with any of the preceding embodiments, except that the sealant composition has a shrinkage of less than 30 percent.

In an alternative embodiment, the instant invention provides a composition, in accordance with any of the preceding embodiments, except that the sealant composition has a shrinkage of less than 20 percent. In an alternative embodiment, the instant invention provides a composition, in accordance with any of the preceding embodiments, except that the sealant composition has a shrinkage of less than 15 percent.

In an alternative embodiment, the instant invention provides a composition, in accordance with any of the preceding embodiments, except that the sealant composition has a shrinkage of less than 10 percent.

In an alternative embodiment, the instant invention provides a composition, in accordance with any of the preceding embodiments, except that the first component comprises one or more first polymer resins and the second component comprises one or more second polymer resins, and wherein the first polymer resin and the second polymer resin have a volume average particle size ratio in the range of 1:5 to 1:2.

In an alternative embodiment, the instant invention provides a composition, in accordance with any of the preceding embodiments, except that the first polymer resin and the second polymer resin have a volume average particle size ratio in the range of about 1:3.

In an alternative embodiment, the instant invention provides a composition, in accordance with any of the preceding embodiments, except that the ultra-high solid content of the polyurethane dispersion comprises 20 to 40 percent by weight of the one or more first polymer resins having a particle size in the range of 0.04 micron to 5.0 micron, and 60 to 80 percent by weight of the one or more second polymer resins having a particle size in the range of 0.05 micron to 5.0 micron, based on the total weight of the one or more first polymer resins and the one or more second polymer resins.

In an alternative embodiment, the instant invention provides a composition, in accordance with any of the preceding embodiments, except that the seed latex is selected from the group consisting of a dispersion, emulsion, or latex of olefins, epoxies, silicon, styrene, acrylate, butadiene, isoprene, vinyl acetate, copolymers thereof, and blends thereof.

In an alternative embodiment, the instant invention provides a composition, in accordance with any of the preceding embodiments, except that the seed latex is an oil phase emulsified in water.

In an alternative embodiment, the instant invention provides a composition, in accordance with any of the preceding embodiments, except that the polyisocyanate is aromatic or aliphatic.

In an alternative embodiment, the instant invention provides a composition, in accordance with any of the preceding embodiments, except that the first polyurethane prepolymer is ionic or non-ionic.

In an alternative embodiment, the instant invention provides a composition, in accordance with any of the preceding embodiments, except that the first polyurethane prepolymer is isocyanate terminated or hydroxyl terminated.

In an alternative embodiment, the instant invention provides a composition, in accordance with any of the preceding embodiments, except that the natural oil based polyol has a functionality in the range of 1.5 to3.

In an alternative embodiment, the instant invention provides a composition, in accordance with any of the preceding embodiments, except that the natural oil based polyol has a functionality in the range of 1.8 to3.

In an alternative embodiment, the instant invention provides a composition, in accordance with any of the preceding embodiments, except that the natural oil based polyol has a functionality in the range of 1.8 to2.2.

In an alternative embodiment, the instant invention provides a composition, in accordance with any of the preceding embodiments, except that the natural oil based polyol has a functionality of about 2.

In an alternative embodiment, the instant invention provides a composition, in accordance with any of the preceding embodiments, except that the natural oil based polyol is blended with one or more conventional polyol.

In an alternative embodiment, the instant invention provides a composition, in accordance with any of the preceding embodiments, except that the natural oil based polyol has a molecular weight in the range of 1000 to 8000 g/mole.

### BRIEF DESCRIPTION OF THE DRAWINGS

For the purpose of illustrating the invention, there is shown in the drawings an exemplary form; it being understood, however, that this invention is not limited to the precise arrangements and instrumentalities shown.

FIG. 1 is a block diagram illustrating a method of making an ultra-high solid content polyurethane dispersion suitable for sealant applications;

FIG. 2 is a block diagram illustrating a first alternative method of making an ultra-high solid content polyurethane dispersion suitable for sealant applications; and

FIG. 3 is a block diagram illustrating a second alternative method of making an ultra-high solid content polyurethane dispersion suitable for sealant applications.

### DETAILED DESCRIPTION OF THE INVENTION

The instant invention is a sealant composition. The instant invention is a sealant composition comprising an ultra-high solid polyurethane dispersion. The ultra-high solid polyurethane dispersion comprises (1) a first component comprising a first polyurethane prepolymer comprising the reaction product of a natural oil based polyol and polyisocyanate, (2) a second component comprising a media phase selected from the group consisting of a second polyurethane prepolymer emulsion, a low solid content polyurethane dispersion, a seed latex, and combinations thereof; and (3) a chain extender. The ultra-high solid polyurethane dispersion has at least a solid content of at least 60 percent by weight of solid content, based on the total weight of the ultra-high solid polyurethane dispersion, and a viscosity of less than 5000 cps at 20 rpm at 21° C. using spindle #4 with Brookfield viscometer. The sealant composition may further include optionally one or more surfactants, optionally one or more dispersants, optionally one or more thickeners, optionally one or more pigments, optionally one or more fillers, optionally one or more freeze-thaw agent, optionally one or more neutralizing agents, optionally one or more plasticizers, and/or combinations thereof.

The terms “polyurethane” and “poly (urea-urethane),” as used herein, may be used interchangeably.

The sealant composition comprises an ultra-high solid content polyurethane dispersion, as described in further details hereinbelow. The sealant composition may further include optionally one or more surfactants, optionally one or more dispersants, optionally one or more thickeners, optionally one or more pigments, optionally one or more fillers, optionally one or more freeze-thaw agent, optionally one or more neutralizing agents, optionally one or more plasticizers, and/or combinations thereof. The sealant composition may further include any other additives. Other exemplary additives include, but are not limited to, mildewcides, fungicides.

The sealant composition may have an elongation flexibility in the range of 100 to 600 at −25° C. All individual values and subranges in the range of 100 to 600 percent at −25° C. are included herein and disclosed herein; for example, the sealant composition may have an elongation in the range of 200 to 500 percent at −25° C.; or in the alternative, the sealant composition may have an elongation in the range of 300 to 500percent at −25° C. In one embodiment, the sealant composition, essentially free of any pigments, may have an elongation flexibility in the range of 100 to 600 percent at −25° C. Essentially free of pigments, as used herein, refers to a pigment weight percent in the range of 0 to less than 0.1, based on the weight of the sealant composition. In an alternative embodiment, the sealant composition comprising 0.1 to 10 percent by weight of one or more pigments may have an elongation flexibility in the range of 100 to 600 percent at −25° C. The sealant composition may have an elongation flexibility in the range of 200 to 2000 percent at 25° C. All individual values and subranges in the range of 200 to 2000 percent at 25° C. are included herein and disclosed herein; for example, the sealant composition may have an elongation in the range of 800 to 1200 percent at 25° C. In one embodiment, the sealant composition, essentially free of any pigments, may have an elongation flexibility in the range of 200 to 2000 percent at 25° C. Essentially free of pigments, as used herein, refers to a pigment weight percent in the range of 0 to less than 0.1, based on the weight of the sealant composition. In an alternative embodiment, the sealant composition comprising 0.1 to 10 percent by weight of one or more pigments may have an elongation flexibility in the range of 200 to 2000 percent at 25° C. The sealant composition may have any elastic recovery; for example, the sealant composition may have an elastic recovery of at least 50 percent at −25° C. All individual values and subranges from at least 50 percent at −25° C. are included herein and disclosed herein; for example, the sealant composition may have an elastic recovery of at least 60 percent at −25° C.; or in the alternative, the sealant composition may have an elastic recovery of at least 70 percent at −25° C.; or in another alternative, the sealant composition may have an elastic recovery in the range of 60 to 80 percent at −25° C. The sealant composition may have a shrinkage of less than 30 percent. All individual values and subranges from less than 30 percent are included herein and disclosed herein; for example, the sealant composition may have a shrinkage of less than 25 percent; or in the alternative, the sealant composition may have a shrinkage of less than 20 percent; or in the alternative, the sealant composition may have a shrinkage of less than 19 percent; or in the alternative, the sealant composition may have a shrinkage of less than 18 percent; or in the alternative, the sealant composition may have a shrinkage of less than 15 percent; or in the alternative, the sealant composition may have a shrinkage of less than 10 percent. The sealant composition may be dried in a shorter period of time relative to other sealant composition.

The sealant composition may further include optionally one or more surfactants. The sealant composition may comprise 0.1 to 5 percent by weight of one or more surfactants. All individual values and subranges from 0.1 to 5 weight percent are included herein and disclosed herein; for example, the weight percent of surfactant can be from a lower limit of 0.1, 0.2, 0.3, or 0.5 weight percent to an upper limit of 1, 2, 3, 4, or 5 weight percent. For example, sealant composition may comprise 0.1 to 4 percent by weight of one or more surfactants; or in the alternative, sealant composition may comprise 0.1 to 3 percent by weight of one or more surfactants; or in the alternative, sealant composition may comprise 0.1 to 2 percent by weight of one or more surfactants; or in the alternative, sealant composition may comprise 0.1 to 1 percent by weight of one or more surfactants. Such surfactants include, but are not limited to, Triton™ X-405 from the Dow Chemical Company, Midland, Mich.

The sealant composition may further include optionally one or more dispersants. The sealant composition may comprise 0.1 to 5 percent by weight of one or more dispersants. All individual values and subranges from 0.1 to 5 weight percent are included herein and disclosed herein; for example, the weight percent of dispersants can be from a lower limit of 0.1, 0.2, 0.3, or 0.5 weight percent to an upper limit of 1, 2, 3, 4, or 5 weight percent. For example, sealant composition may comprise 0.1 to 4 percent by weight of one or more dispersants; or in the alternative, sealant composition may comprise 0.1 to 3 percent by weight of one or more dispersants; or in the alternative, sealant composition may comprise 0.1 to 2 percent by weight of one or more dispersants; or in the alternative, sealant composition may comprise 0.1 to 1 percent by weight of one or more dispersants. Such surfactants are commercially available under the tradename Tamol™ from Rohm and Has, Philadelphia, USA.

The sealant composition may further include optionally one or more thickeners. The sealant composition may comprise 0.1 to 5 percent by weight of one or more thickeners. All individual values and subranges from 0.1 to 5 weight percent are included herein and disclosed herein; for example, the weight percent of thickeners can be from a lower limit of 0.1, 0.2, 0.3, or 0.5 weight percent to an upper limit of 1, 2, 3, 4, or 5 weight percent. For example, sealant composition may comprise 0.1 to 4 percent by weight of one or more thickeners; or in the alternative, sealant composition may comprise 0.1 to 3 percent by weight of one or more thickeners; or in the alternative, sealant composition may comprise 0.1 to 2 percent by weight of one or more thickeners; or in the alternative, sealant composition may comprise 0.1 to 1 percent by weight of one or more thickeners. Such thickeners are commercially available under the tradename UCAR™ or Celosize™ from the Dow Chemical Company, Midland, Mich.

The sealant composition may further include optionally one or more pigments. The sealant composition may comprise 0 to 10 percent by weight of one or more pigments. All individual values and subranges from 0 to 10 weight percent are included herein and disclosed herein; for example, the weight percent of pigments can be from a lower limit of 0.1, 0.2, 0.3, 0.5, 1, 2, 3, 4, or 5 weight percent to an upper limit of 1, 2, 3, 4, 5, 6, 7, 8, 9, or 10 weight percent. For example, sealant composition may comprise 0 to 9 percent by weight of one or more pigments; or in the alternative, sealant composition may comprise 0.1 to 8 percent by weight of one or more pigments; or in the alternative, sealant composition may comprise 0.1 to 7 percent by weight of one or more pigments; or in the alternative, sealant composition may comprise 0.1 to 6 percent by weight of one or more pigments. Such pigments include, but are not limited to, titanium dioxide, which are commercially available under the tradename Ti-Pure™ from the DuPont, Wilmington, Del., USA.

The sealant composition may further include optionally one or more fillers. The sealant composition may comprise 0 to 80 percent by weight of one or more fillers. All individual values and subranges from 0 to 80 weight percent are included herein and disclosed herein; for example, the weight percent of fillers can be from a lower limit of 0.1, 0.2, 0.3, 0.5, 1, 2, 3, 4, 5, 10, 20, 30, or 40 weight percent to an upper limit of 15, 20, 25, 35, 45, 55, 65, 75, or 80 weight percent. For example, sealant composition may comprise 0 to 75 percent by weight of one or more fillers; or in the alternative, sealant composition may comprise 0 to 65 percent by weight of one or more fillers; or in the alternative, sealant composition may comprise 0 to 55 percent by weight of one or more fillers; or in the alternative, sealant composition may comprise 0 to 45 percent by weight of one or more fillers. Such fillers include, but are not limited to, calcium carbonate, commercially available under the tradename Drikalite™ from the Imeyrys, Victoria, Australia, barium sulfate, aluminum silicate, ceramic micro-spheres, glass micro-spheres, and fly ash.

The sealant composition may further include optionally one or more freeze-thaw agents. The sealant composition may comprise 0.1 to 2 percent by weight of one or more freeze-thaw agents. All individual values and subranges from 0.1 to 2 weight percent are included herein and disclosed herein; for example, the weight percent of freeze-thaw agents can be from a lower limit of 0.1, 0.2, 0.3, or 0.5 weight percent to an upper limit of 05, 1, 1.5, or 2 weight percent. For example, sealant composition may comprise 0.1 to 2 percent by weight of one or more freeze-thaw agents; or in the alternative, sealant composition may comprise 0.1 to 1.5 percent by weight of one or more freeze-thaw agents; or in the alternative, sealant composition may comprise 0.1 to 1 percent by weight of one or more freeze-thaw agents; or in the alternative, sealant composition may comprise 0.1 to 0.5 percent by weight of one or more freeze-thaw agents. Freeze-thaw agents, as used herein, refer to additives that typically prevent coagulation of the dispersion when exposed to extreme temperature cycles. Such freeze-thaw agents include, but are not limited to, glycols such as ethylene glycol, diethylene glycol, propylene glycol, dipropylene glycol, butylene glycol, dibutylene glycol. Such glycols are commercially available from the Dow Chemical Company, Midland, Mich.

The sealant composition may further include optionally one or more neutralizing agents. The sealant composition may comprise 0.1 to 2 percent by weight of one or more neutralizing agents. All individual values and subranges from 0.1 to 2 weight percent are included herein and disclosed herein; for example, the weight percent of neutralizing agents can be from a lower limit of 0.1, 0.2, 0.3, or 0.5 weight percent to an upper limit of 05, 1, 1.5, or 2 weight percent. For example, sealant composition may comprise 0.1 to 2 percent by weight of one or more neutralizing agents; or in the alternative, sealant composition may comprise 0.1 to 1.5 percent by weight of one or more neutralizing agents; or in the alternative, sealant composition may comprise 0.1 to 1 percent by weight of one or more neutralizing agents; or in the alternative, sealant composition may comprise 0.1 to 0.5 percent by weight of one or more neutralizing agents. Neutralizing agents are typically used to control pH to provide stability to the formulated sealant composition. Such neutralizing agents include, but are not limited to, aqueous ammonia or aqueous amines, or other aqueous inorganic salts.

The sealant composition may further include optionally one or more plasticizers. The sealant composition may comprise 0 to 12 percent by weight of one or more plasticizers. All individual values and subranges from 0 to 12 weight percent are included herein and disclosed herein; for example, the weight percent of plasticizers can be from a lower limit of 0.1, 0.2, 0.3, 0.5, 1, 2, 3, 4, or 5 weight percent to an upper limit of 1, 2, 3, 4, 5, 6, 7, 8, 9, 10, or 12 weight percent. For example, sealant composition may comprise 0 to 12 percent by weight of one or more plasticizers; or in the alternative, sealant composition may comprise 0 to 10 percent by weight of one or more plasticizers; or in the alternative, sealant composition may comprise 0 to 7 percent by weight of one or more plasticizers; or in the alternative, sealant composition may comprise 0 to 6 percent by weight of one or more plasticizers. Such plasticizers are commercially available under the tradename Jayflex™ from ExxonMobil Chemical Company, Texas, USA.

The sealant composition may comprise 25 to less than 100 percent by weight of ultra-high solid polyurethane dispersion. All individual values and subranges from 25 to less than 100 weight percent are included herein and disclosed herein; for example, the weight percent of ultra-high solid polyurethane dispersion can be from a lower limit of 25, 30, 35, 45, 55, or 65 weight percent to an upper limit of 35, 45, 55, 65, 70, 80, 85, 90, 95, or 99 weight percent. For example, sealant composition may comprise 35 to less than 100 percent by weight of ultra-high solid polyurethane dispersion; or in the alternative, sealant composition may comprise 45 to less than 100 percent by weight of ultra-high solid polyurethane dispersion; or in the alternative, sealant composition may comprise 55 to less than 100 percent by weight of ultra-high solid polyurethane dispersion; or in the alternative, sealant composition may comprise 65 to less than 100 percent by weight of ultra-high solid polyurethane dispersion.

The ultra-high solid polyurethane dispersion comprises (1) a first component comprising a first polyurethane prepolymer comprising the reaction product of a natural oil based polyol and polyisocyanate, (2) a second component comprising a media phase selected from the group consisting of a second polyurethane prepolymer emulsion, a low solid content polyurethane dispersion, a seed latex, and combinations thereof; and (3) a chain extender. The ultra-high solid content polyurethane dispersion may have any number of polymers; for example, the ultra-high solid content polyurethane dispersion may comprise at least two or more different polymers. The ultra-high solid content polyurethane dispersion may, for example, comprise a first polymer and a second polymer. First polymer may, for example, be a first polyurethane, and the second polymer may be a second polyurethane, polyolefin, polyacrylate, combinations thereof, or the like. The ultra-high solid content polyurethane dispersion may comprise from 5 to 95 percent by weigh of the first polymer, and from 5 to 95 percent by weight of the second polymer, based on the total weight of the ultra-high solid content of the polyurethane dispersion. All individual values and subranges from 5 to 95 weight percent are included herein and disclosed herein; for example, ultra-high solid content polyurethane dispersion may comprise from 5 to 45 percent by weigh of the first polymer, and from 55 to 95 percent by weight of the second polymer, based on the total weight of the ultra-high solid content polyurethane dispersion; or in the alternative, ultra-high solid content polyurethane dispersion may comprise from 20 to 60 percent by weigh of the first polymer, and from 40 to 80 percent by weight of the second polymer, based on the total weight of the ultra-high solid content polyurethane dispersion.

The ultra-high solid content polyurethane dispersion may comprise at least 60 percent by weight of solid content, excluding the weight of any filler, based on the total weight of the ultra-high solid content polyurethane dispersion. All individual values and subranges of at least 60 weight percent are included herein and disclosed herein; for example, the ultra-high solid content polyurethane dispersion may comprise at least 65 percent by weight of solid content, excluding the weight of any filler, based on the total weight of the ultra-high solid content polyurethane dispersion; or in the alternative, the ultra-high solid content polyurethane dispersion may comprise at least 70 percent by weight of solid content, excluding the weight of any filler, based on the total weight of the ultra-high solid content polyurethane dispersion. The ultra-high solid content polyurethane dispersion may comprise less than 40 percent by weight of water, based on the total weight of the ultra-high solid content polyurethane dispersion. All individual values and subranges of less than 40 weight percent are included herein and disclosed herein; for example, the ultra-high solid content polyurethane dispersion may comprise less than 35 percent by weight of water, based on the total weight of the ultra-high solid content polyurethane dispersion; or in the alternative, the ultra-high solid content polyurethane dispersion may comprise less than 30 percent by weight of water, based on the total weight of the ultra-high solid content polyurethane dispersion. The ultra-high solid content polyurethane dispersion may, for example, comprise of at least two volume average particle size diameters; for example, the ultra-high solid content polyurethane dispersion may, for example, comprise of a first volume average particle size diameter, and a second volume average particle size diameter. Volume average particle size diameter, as used herein, refers to

$$Dv = {[ \frac{\sum {n}_{i} {d}_{i}^{3}}{\sum {n}_{i}} ]}^{1 / 3} ;$$

wherein where Dᵥ is the volume average particle size, n, is the number of particles of diameter dᵢ; and Polydispersity index (“PDI”), as used herein refers to

$$PDI = \frac{[ \frac{\sum {n}_{n} {d}_{i}^{4}}{\sum {n}_{i} {d}_{i}} ]}{[ \frac{\sum {n}_{i} {d}_{i}}{\sum {n}_{i}} ]} .$$

Additionally, the ultra-high solid content polyurethane dispersion may comprise particles having one or more volume average particle size diameters. The first volume average particle size diameter may be in the range of 0.05 to 5.0 micron. All individual values and subranges from 0.05 to 5.0 micron are included herein and disclosed herein; for example, the first volume average particle size diameter may be in the range of 0.07 to 1.0 micron; or in the alternative, the first volume average particle size diameter may be in the range of 0.08 to 0.2 micron. The second volume average particle size diameter may be in the range of 0.05 to 5.0 micron. All individual values and subranges from 0.05 to 5.0 micron are included herein and disclosed herein; for example, the second volume average particle size diameter may be in the range of 0.07 to 1.0 micron; or in the alternative, the second volume average particle size diameter may be in the range of 0.08 to 0.2 micron. The ultra-high solid content polyurethane dispersion may have a bimodal or multimodal particle size distribution. The ultra-high solid content polyurethane dispersion may have any particle size distributions; for example, the ultra-high solid content polyurethane dispersion may have a particle size distribution in the range of 1: 2 to 1:20 based on the percent volume of first volume average particle size diameter to the second volume average particle size diameter. All individual values and subranges from 1:2 to 1:20 are included herein and disclosed herein; for example, the ultra-high solid content polyurethane dispersion may have a particle size distribution in the range of 1:2 to 1:10 based on the percent volume of the first volume average particle size diameter to second volume average particle size; or in the alternative, the ultra-high solid content polyurethane dispersion may have a particle size distribution in the range of 1:3 to 1:5 based on the percent volume of the first volume average particle size diameter to the second volume average particle size diameter. The particle volume average particle size diameter and particle size distribution are important factors to the instant invention because these factors facilitate the production of the inventive ultra-high solid content polyurethane dispersions while maintaining lower viscosities. The ultra-high solid content polyurethane dispersion may have a polydispersity index (M_{w}/M_{z}) in the range of less than 5. All individual values and subranges in the range of less than 5 are included herein and disclosed herein; for example, the ultra-high solid content polyurethane dispersion may have a polydispersity index (M_{w}/M_{z}) in the range of less than 3; or in the alternative, the ultra-high solid content polyurethane dispersion may have a polydispersity index (M_{w}/M_{z}) in the range of less than 2. The ultra-high solid content polyurethane dispersion may have a viscosity in the range of less than 5000 cps at 20 rpm at 21° C. using spindle #4 with Brookfield viscometer. All individual values and subranges in the range of less than 5000 cps at 20 rpm at 21° C. using spindle #4 with Brookfield viscometer are included herein and disclosed herein; for example, the ultra-high solid content polyurethane dispersion may have a viscosity in the range of less than 4000 cps at 20 rpm at 21° C. using spindle #4 with Brookfield viscometer; or in the alternative, the ultra-high solid content polyurethane dispersion may have a viscosity in the range of less than 3500 cps at 20 rpm at 21° C. using spindle #4 with Brookfield viscometer.

The first component may be a first polyurethane prepolymer comprising the reaction product of a natural oil based polyol and polyisocyanate.

The term “first polyurethane prepolymer,” as used herein refers to a stream containing a first polyurethane prepolymer. The first polyurethane prepolymer contains substantially no organic solvent and also has at least two isocyanate groups per one molecule. Such a first urethane prepolymer, as used herein, further refers to a polyurethane prepolymer wherein the content of the organic solvent in the polyurethane prepolymer is 10% by weight or less based on the total weight of the first polyurethane prepolymer. To eliminate the step of removing the organic solvent, the content of the organic solvent may, for example, be 5% by weight or less based on the total weight of the first polyurethane prepolymer; or in the alternative, the content of the organic solvent may be 1% by weight or less based on the total weight of the first polyurethane prepolymer; or in another alternative, the content of the organic solvent may be 0.1% by weight or less based on the total weight of the first polyurethane prepolymer.

The number average molecular weight of the first polyurethane prepolymer used in the present invention may, for example, be within the range from 1,000 to 200,000. All individual values and subranges from 1,000 to 200,000 are included herein and disclosed herein; for example, the first polyurethane prepolymer may have a number average molecular weight in the range of 2,000 to about 20,000. The polyurethane prepolymer may further include small amounts of monomeric isocyanates.

The first polyurethane prepolymer used in the present invention may be produced by any conventionally known processes, for example, solution process, hot melt process, or prepolymer mixing process. Furthermore, the first polyurethane prepolymer may, for example, be produced via a process for reacting a polyisocyanate compound with an active hydrogen-containing compound and examples thereof include 1) a process for reacting a polyisocyanate compound with a polyol compound without using an organic solvent, and 2) a process for reacting a polyisocyanate compound with a polyol compound in an organic solvent, followed by removal of the solvent.

For example, the polyisocyanate compound may be reacted with the active hydrogen-containing compound at a temperature in the range of 20° C. to 120° C.; or in the alternative, in the range of 30° C. to 100° C., at an equivalent ratio of an isocyanate group to an active hydrogen group of, for example, from 1.1:1 to 3:1; or in the alternative, from 1.2:1 to 2:1. In the alternative, the prepolymer may be prepared with an excess amount of polyols thereby facilitating the production of hydroxyl terminal polymers.

For example, an excess isocyanate group may optionally be reacted with aminosilane, thereby converting the terminal group into a reactive group other than isocyanate group, such as an alkoxysilyl group.

The first polyurethane prepolymer may further include a polymerizable acrylic, styrenic, or vinyl monomers as a diluent, which can then be polymerized by free radical polymerization via an initiator.

Examples of the polyisocyanate compound include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3 and 1,4-bis(isocyanatemethyl)isocynate, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmethane diisocyanate, isomers thereof, and/or combinations thereof.

The active hydrogen-containing compound used to produce the first polyurethane prepolymer used in the present invention includes, but is not limited to, for example, a compound having comparatively high molecular weight (hereinafter referred to as a first high-molecular weight compound) and a compound having comparatively low molecular weight (hereinafter referred to as a first low-molecular weight compound).

The number average molecular weight of the first high-molecular weight compound may, for example, be within a range from 300 to 20,000; or in the alternative, within a range from 500 to 5,000. The number average molecular weight of the first low-molecular weight compound may, for example, be less than 300. These active hydrogen-containing compounds may be used alone, or two or more kinds of them may be used in combination.

Among these active hydrogen-containing compounds, examples of the first high-molecular weight compound include, but are not limited to aliphatic and aromatic polyester polyols including caprolactone based polyester polyols, seed oil based polyester polyols, any polyester/polyether hybrid polyols, PTMEG-based polyether polyols; polyether polyols based on ethylene oxide, propylene oxide, butylene oxide and mixtures thereof; polycarbonate polyols; polyacetal polyols, polyacrylate polyols; polyesteramide polyols; polythioether polyols; polyolefin polyols such as saturated or unsaturated polybutadiene polyols.

The natural oil based polyols are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. Examples of animal products include lard, beef tallow, fish oils and mixtures thereof. A combination of vegetable and animal based oils/fats may also be used.

Several chemistries can be used to prepare the natural oil based polyols. Such modifications of a renewable resource include, for example, epoxidation, hydroxylation, ozonolysis, esterification, hydroformylation, or alkoxylation. Such modifications are commonly known in the art and are described, for example, in U.S. Pat. Nos. 4,534,907, 4,640,801, 6,107,433, 6,121,398, 6,897,283, 6,891,053, 6,962,636, 6,979,477, and PCT publication Nos. WO 2004/020497, WO 2004/096744, and WO 2004/096882.

After the production of such polyols by modification of the natural oils, the modified products may be further alkoxylated. The use of ethylene oxide (EO) or mixtures of EO with other oxides, introduce hydrophilic moieties into the polyol. In one embodiment, the modified product undergoes alkoxylation with sufficient EO to produce a natural oil based polyol with between about 10 weight % and about 60 weight % percent EO; preferably between about 20 weight % and about 40 weight % EQ.

In another embodiment, the natural oil based polyols are obtained by a multi-step process wherein the animal or vegetable oils/fats is subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols. The initiator for use in the multi-step process for the production of the natural oil based polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-cyclohexanedimethanol; 1,3-cyclohexanedimethanol; mixture of 1,3- and 1,4-cyclohexanedimethanol (UNOXOL™-diol); 8,8-bis(hydroxymethyl)tricyclo[5,2,1,0^{2.6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. More preferably, the initiator is glycerol, trimethylopropane, pentaerythritol, sucrose, sorbitol, and/or mixture thereof.

In one embodiment, the initiators are alkoxlyated with ethylene oxide or a mixture of ethylene oxide and at least one other alkylene oxide to give an alkoxylated initiator with a molecular weight between about 200 and about 6000, preferably between about 500 and about 3000.

The functionality of the at least one natural oil based polyol, is above about 1.5 and generally not higher than about 6. In one embodiment, the functionality of the at least one natural oil based polyol is in the range of 1.5 to 3. In one embodiment, the functionality of the at least one natural oil based polyol is in the range of 1.5 to 2.5. In one embodiment, the functionality of the at least one natural oil based polyol is about 2. In one embodiment, the functionality is below about 4. The hydroxyl number of the at least one natural oil based polyol is below about 300 mg KOH/g, preferably between about 50 and about 300, more preferably between about 60 and about 200. In one embodiment, the hydroxyl number is below about 100.

The level of renewable feedstock in the natural oil based polyol can vary between about 10 and about 100%, usually between about 10 and about 90%.

The natural oil based polyols may constitute up to about 90 weight % of the polyol blend.

However, in one embodiment, the natural oil based polyol may constitute at least 5 weight %, at least 10 weight %, at least 25 weight %, at least 35 weight %, at least 40 weight %, at least 50 weight %, or at least 55 weight % of the total weight of the polyol blend. The natural oil based polyols may constitute 40% or more, 50 weight % or more, 60 weight % or more, 75 weight % or more, 85 weight % or more, 90 weight % or more, or 95 weight % or more of the total weight of the combined polyols.

Combination of two types or more of natural oil based polyols may also be used, either to maximize the level of seed oil in the foam formulation, or to optimize foam processing and/or specific foam characteristics, such as resistance to humid aging.

The viscosity measured at 25° C. of the natural oil based polyols is generally less than about 6,000 mPa.s. Preferably, the viscosity is less than about 5,000 mPa.s.

As the polyester polyol, polyester polyol, for example, obtained by the polycondensation reaction of a glycol and an acid may be used.

Examples of the glycol, which can be used to obtain the polyester polyol, include, but are not limited to, ethylene glycol, propylene glycol, 1,3-propanediol, 1,4-butanediol, 1,5-pentanediol, 3-methyl- 1,5-pentanediol, 1,6-hexanediol, neopentyl glycol, diethylene glycol, triethylene glycol, tetraethylene glycol, polyethylene glycol, dipropylene glycol, tripropylene glycol, bishydroxyethoxybenzene, 1,4-cyclohexanediol, 1,4-cyclohexanedimethanol, 1,3-cyclohexanedimethanol, mixture of 1,3- and 1,4-cyclohexanedimethanol (UNOXOL™-diol), bisphenol A, hydrogenated bisphenol A, hydroquinone, and alkylene oxide adducts thereof.

Examples of the acid, which can be used to obtain the polyester polyol, include, but are not limited to, succinic acid, adipic acid, azelaic acid, sebacic acid, dodecanedicarboxylic acid, maleic anhydride, fumaric acid, 1,3-cyclopentanedicarboxylic acid, 1,4-cyclohexanedicarboxylic acid, terephthalic acid, isophthalic acid, phthalic acid, 1,4-naphthalenedicarboxylic acid, 2,5-naphthalenedicarboxylic acid, 2,6-naphthalenedicarboxylic acid, naphthalic acid, biphenyldicarboxylic acid, 1,2-bis(phenoxy)ethane-p,p′-dicarboxylic acid, and anhydrides or ester-forming derivatives of these dicarboxylic acids; and p-hydroxybenzoic acid, p-(2-hydroxyethoxy)benzoic acid, and ester-forming derivatives of these hydroxycarboxylic acids. Also a polyester obtained by the ring-opening polymerization reaction of a cyclic ester compound such as ∈-caprolactone, and copolyesters thereof may be used.

The polyester polyols may also be produced by transesterification of the above-mentioned diols and triols with hydroxy group containing fatty acid methyl esters.

Examples of the polyether polyol include, but are not limited to, compounds obtained by the polyaddition reaction of one or more kinds of compounds having at least two active hydrogen atoms such as ethylene glycol, diethylene glycol, triethylene glycol, propylene glycol, trimethylene glycol, 1,3-butanediol, 1,4-butanediol, 1,6-hexanediol, neopentyl glycol, glycerin, trimethylolethane, trimethylolpropane, sorbitol, sucrose, ethylenediamine, diethylenetriamine, triisopropanolamine, pyrogallol, dihydroxybenzoic acid, hydroxyphthalic acid, and 1,2,3-propanetrithiol with one or more kinds among ethylene oxide, propylene oxide, butylene oxide, styrene oxide, epichlorohydrin, and tetrahydrofuran.

Examples of the polycarbonate polyol include, but are not limited to, compounds obtained by the reaction of glycols such as 1,4-butanediol, 1,6-hexanediol, and diethylene glycol, with diphenyl carbonate and phosgene.

Among the active hydrogen-containing compounds, the first low-molecular weight compound is a compound which has at least two active hydrogens per one molecule and has a number average molecular weight of less than 300, and examples thereof include, but are not limited to, glycol components used as raw materials of the polyester polyol; polyhydroxy compounds such as glycerin, trimethylolethane, trimethylolpropane, sorbitol, and pentaerythritol; and amine compounds such as ethylenediamine, 1, 6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, 1,4-cyclohexanediamine, 1,2-propanediamine, hydazine, diethylenetriamine, and triethylenetetramine.

The first urethane prepolymer may further include a hydrophilic group. The term “hydrophilic group,” as used herein, refers to an anionic group (for example, carboxyl group, sulfonic acid group, or phosphoric acid group), or a cationic group (for example, tertiary amino group, or quaternary amino group), or a nonionic hydrophilic group (for example, a group composed of a repeating unit of ethylene oxide, or a group composed of a repeating unit of ethylene oxide and a repeating unit of another alkylene oxide).

Among hydrophilic groups, a nonionic hydrophilic group having a repeating unit of ethylene oxide may, for example, be preferred because the finally obtained polyurethane emulsion has excellent compatibility with other kinds of emulsions. Introduction of a carboxyl group and/or a sulfonic acid group is effective to make the particle size finer.

The ionic group refers to a functional group capable of serving as a hydrophilic ionic group which contributes to self dispersibility in water by neutralization, providing colloidal stability during the processing against agglomeration; stability during shipping, storage and formulation with other additives. These hydrophilic groups could also introduce application specific properties such as adhesion.

When the ionic group is an anionic group, the neutralizer used for neutralization includes, for example, nonvolatile bases such as sodium hydroxide and potassium hydroxide; and volatile bases such as tertiary amines (for example trimethylamine, triethylamine, dimethylethanolamine, methyldiethanolamine, and triethanolamine) and ammonia can be used.

When the ionic group is a cationic group, usable neutralizer includes, for example, inorganic acids such as hydrochloric acid, sulfuric acid, and nitric acid; and organic acids such as formic acid and acetic acid.

Neutralization may be conducted before, during or after the polymerization of the compound having an ionic group. Alternatively, neutralization may be conducted during or after the polyurethane polymerization reaction.

To introduce a hydrophilic group in the first polyurethane prepolymer, a compound, which has at least one active hydrogen atom per one molecule and also has the above hydrophilic group, may be used as an active hydrogen-containing compound. Examples of the compound, which has at least one active hydrogen atom per one molecule and also has the above hydrophilic group, include:

(1) sulfonic acid group-containing compounds such as 2-oxyethanesulfonic acid, phenolsulfonic acid, sulfobenzoic acid, sulfosuccinic acid, 5-sulfoisophthalic acid, sulfanilic acid, 1,3-phenylenediamine-4,6-disulfonic acid, and 2,4-diaminotoluene-5-sulfonic acid, and derivatives thereof, or polyester polyols obtained by copolymerizing them;

(2) carboxylic acid-containing compounds such as 2,2-dimethylolpropionic acid, 2,2-dimethylolbutyric acid, 2,2-dimethylolvaleric acid, dioxymaleic acid, 2,6-dioxybenzoic acid, and 3,4-diaminobenzoic acid, and derivatives thereof, or polyester polyols obtained by copolymerizing them; tertiary amino group-containing compounds such as methyldiethanolamine, butyldiethanolamine, and alkyldiisopropanolamine, and derivatives thereof, or polyester polyol or polyether polyol obtained by copolymerizing them;

(3) reaction products of the above tertiary amino group-containing compounds, or derivatives thereof, or polyester polyols or polyether polyols obtained by copolymerizing them, with quaternizing agents such as methyl chloride, methyl bromide, dimethylsulfuric acid, diethylsulfuric acid, benzyl chloride, benzyl bromide, ethylenechlorohydrin, ethylenebromohydrin, epichlorohydrin, and bromobutane;

(4) nonionic group-containing compounds such as polyoxyethylene glycol or polyoxyethylene-polyoxypropylene copolymer glycol, which has at least 30% by weight of a repeating unit of ethylene oxide and at least one active hydrogen in the polymer and also has a molecular weight of 300 to 20,000, polyoxyethylene-polyoxybutylene copolymer glycol, polyoxyethylene-polyoxyalkylene copolymer glycol, and monoalkyl ether thereof, or polyester-polyether polyols obtained by copolymerizing them; and

(5) combinations thereof.

The second component may be a selected from the group consisting of a second polyurethane prepolymer, a second polyurethane prepolymer emulsion, a low solid content polyurethane dispersion, a seed latex, and combinations thereof.

The term “second polyurethane prepolymer emulsion,” as used herein refers to a stream containing a second polyurethane prepolymer. The second polyurethane prepolymer contains substantially no organic solvent and also has at least two isocyanate groups per one molecule. Such a second polyurethane prepolymer, as used herein, further refers to a polyurethane prepolymer wherein the content of the organic solvent in the polyurethane prepolymer is 10% by weight or less based on the total weight of the second polyurethane prepolymer. To eliminate the step of removing the organic solvent, the content of the organic solvent may, for example, be 5% by weight or less based on the total weight of the second polyurethane prepolymer; or in the alternative, the content of the organic solvent may be 1% by weight or less based on the total weight of the second polyurethane prepolymer; or in another alternative, the content of the organic solvent may be 0.1% by weight or less based on the total weight of the second polyurethane prepolymer.

The number average molecular weight of the second polyurethane prepolymer used in the present invention may, for example, be within the range from 1,000 to 200,000. All individual values and subranges from 1,000 to 200,000 are included herein and disclosed herein; for example, the second polyurethane prepolymer may have a number average molecular weight in the range of 2,000 to about 20,000. The polyurethane prepolymer may further include small amounts of monomeric isocyanates.

The second polyurethane prepolymer used in the present invention may be produced by any conventionally known processes, for example, solution process, hot melt process, or prepolymer mixing process. Furthermore, the second urethane prepolymer may, for example, be produced via a process for reacting a polyisocyanate compound with an active hydrogen-containing compound and examples thereof include 1) a process for reacting a polyisocyanate compound with a polyol compound without using an organic solvent, and 2) a process for reacting a polyisocyanate compound with a polyol compound in an organic solvent, followed by removal of the solvent. The final prepolymer may be NCO or OH terminated.

For example, the polyisocyanate compound may be reacted with the active hydrogen-containing compound at a temperature in the range of 20° C. to 120° C.; or in the alternative, in the range of 30° C. to 100° C., at an equivalent ratio of an isocyanate group to an active hydrogen group of, for example, from 1.1:1 to 3:1, or in the alternative, from 1.2:1 to 2:1. In the alternative, the prepolymer may be prepared with an excess amount of polyols thereby facilitating the production of hydroxyl terminal polymers.

For example, an excess isocyanate group may optionally be reacted with aminosilane, thereby converting the terminal group into a reactive group other than isocyanate group, such as an alkoxysilyl group.

The second polyurethane prepolymer may further include a polymerizable acrylic, styrenic, or vinyl monomers as a diluent, which can then be polymerized by free radical polymerization via an initiator.

Examples of the polyisocyanate compound include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3 and 1,4-bis(isocyanatemethyl) isocynate, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmethane diisocyanate, isomers thereof, and/or combinations thereof. Aromatic or aliphatic isocyanate may be used; however, aliphatic isocyanates may be preferred.

The active hydrogen-containing compound used to produce the second polyurethane prepolymer used in the present invention includes, but is not limited to, for example, a compound having comparatively high molecular weight (hereinafter referred to as a second high-molecular weight compound) and a compound having comparatively low molecular weight (hereinafter referred to as a second low-molecular weight compound).

The number average molecular weight of the second high-molecular weight compound may, for example, be within a range from 300 to 20,000; or in the alternative, within a range from 500 to 5,000. The number average molecular weight of the second low-molecular weight compound may, for example, be less than 300. These active hydrogen-containing compounds may be used alone, or two or more kinds of them may be used in combination.

Among these active hydrogen-containing compounds, examples of the second high-molecular weight compound include, but are not limited to aliphatic and aromatic polyester polyols including caprolactone based polyester polyols, seed oil based polyester polyols, any polyester/polyether hybrid polyols, PTMEG-based polyether polyols; polyether polyols based on ethylene oxide, propylene oxide, butylene oxide and mixtures thereof; polycarbonate polyols; polyacetal polyols; polyacrylate polyols; polyesteramide polyols; polythioether polyols; and polyolefin polyols such as saturated or unsaturated polybutadiene polyols.

The natural oil based polyols are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. Examples of animal products include lard, beef tallow, fish oils and mixtures thereof. A combination of vegetable and animal based oils/fats may also be used.

Several chemistries can be used to prepare the natural oil based polyols. Such modifications of a renewable resource include, for example, epoxidation, hydroxylation, ozonolysis, esterification, hydroformylation, or alkoxylation. Such modifications are commonly known in the art and are described, for example, in U.S. Pat. Nos. 4,534,907, 4,640,801, 6,107,433, 6,121,398, 6,897,283, 6,891,053, 6,962,636, 6,979,477, and PCT publication Nos. WO 2004/020497, WO 2004/096744, and WO 2004/096882.

After the production of such polyols by modification of the natural oils, the modified products may be further alkoxylated. The use of ethylene oxide (EO) or mixtures of EO with other oxides, introduce hydrophilic moieties into the polyol. In one embodiment, the modified product undergoes alkoxylation with sufficient EO to produce a natural oil based polyol with between about 10 weight % and about 60 weight % percent EO; preferably between about 20 weight % and about 40 weight % EQ.

In another embodiment, the natural oil based polyols are obtained by a multi-step process wherein the animal or vegetable oils/fats is subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil based polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. More preferably, the initiator is glycerol, trimethylopropane, pentaerythritol, sucrose, sorbitol, and/or mixture thereof.

In one embodiment, the initiators are alkoxlyated with ethylene oxide or a mixture of ethylene oxide and at least one other alkylene oxide to give an alkoxylated initiator with a molecular weight between about 200 and about 6000, preferably between about 500 and about 3000.

The functionality of the at least one natural oil based polyol, is above about 1.5 and generally not higher than about 6. In one embodiment, the functionality of the at least one natural oil based polyol is in the range of 1.5 to 3. In one embodiment, the functionality of the at least one natural oil based polyol is in the range of 1.5 to 2.5. In one embodiment, the functionality of the at least one natural oil based polyol is about 2. In one embodiment, the functionality is below about 4. The hydroxyl number of the at least one natural oil based polyol is below about 300 mg KOH/g, preferably between about 50 and about 300, more preferably between about 60 and about 200. In one embodiment, the hydroxyl number is below about 100.

The level of renewable feedstock in the natural oil based polyol can vary between about 10 and about 100%, usually between about 10 and about 90%.

The natural oil based polyols may constitute up to about 90 weight % of the polyol blend. However, in one embodiment, the natural oil based polyol may constitute at least 5 weight %, at least 10 weight %, at least 25 weight %, at least 35 weight %, at least 40 weight %, at least 50 weight %, or at least 55 weight % of the total weight of the polyol blend. The natural oil based polyols may constitute 40% or more, 50 weight % or more, 60 weight % or more, 75 weight % or more, 85 weight % or more, 90 weight % or more, or 95 weight % or more of the total weight of the combined polyols.

Combination of two types or more of natural oil based polyols may also be used, either to maximize the level of seed oil in the foam formulation, or to optimize foam processing and/or specific foam characteristics, such as resistance to humid aging.

The viscosity measured at 25° C. of the natural oil based polyols is generally less than about 6,000 mPa.s. Preferably, the viscosity is less than about 5,000 mPa.s.

As the polyester polyol, polyester polyols, for example, obtained by the polycondensation reaction of a glycol and an acid may be used.

Examples of the glycol, which can be used to obtain the polyester polyol, include, but are not limited to, ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, polyethylene glycol, dipropylene glycol, tripropylene glycol, bishydroxyethoxybenzene, 1,4-cyclohexanediol, 1,4-cyclohexanedimethanol, bisphenol A, mixture of 1,3- and 1,4-cyclohexanedimethanol (UNOXOL™-diol), hydrogenated bisphenol A, hydroquinone, and alkylene oxide adducts thereof.

Examples of the acid, which can be used to obtain the polyester polyol, include, but are not limited to, succinic acid, adipic acid, azelaic acid, sebacic acid, dodecanedicarboxylic acid, maleic anhydride, fumaric acid, 1,3-cyclopentanedicarboxylic acid, 1,4-cyclohexanedicarboxylic acid, terephthalic acid, isophthalic acid, phthalic acid, 1,4-naphthalenedicarboxylic acid, 2,5-naphthalenedicarboxylic acid, 2,6-naphthalenedicarboxylic acid, naphthalic acid, biphenyldicarboxylic acid, 1,2-bis(phenoxy)ethane-p,p′-dicarboxylic acid, and anhydrides or ester-forming derivatives of these dicarboxylic acids; and p-hydroxybenzoic acid, p-(2-hydroxyethoxy)benzoic acid, and ester-forming derivatives of these hydroxycarboxylic acids.

Also a polyester obtained by the ring-opening polymerization reaction of a cyclic ester compound such as ∈-caprolactone, and copolyesters thereof can be used.

The polyester polyols can also be produced by transesterification of the above mentioned diols and triols with hydroxy group containing fatty acid methyl esters.

Examples of the polyether polyol include, but are not limited to, compounds obtained by the polyaddition reaction of one or more kinds of compounds having at least two active hydrogen atoms such as ethylene glycol, diethylene glycol, triethylene glycol, propylene glycol, trimethylene glycol, 1,3-butanediol, 1,4-butanediol, 1,6-hexanediol, neopentyl glycol, glycerin, trimethylolethane, trimethylolpropane, sorbitol, sucrose, ethylenediamine, diethylenetriamine, triisopropanolamine, pyrogallol, dihydroxybenzoic acid, hydroxyphthalic acid, and 1,2,3-propanetrithiol with one or more kinds among ethylene oxide, propylene oxide, butylene oxide, styrene oxide, epichlorohydrin, and tetrahydrofuran.

Examples of the polycarbonate polyol include, but are not limited to, compounds obtained by the reaction of glycols such as 1,4-butanediol, 1,6-hexanediol, and diethylene glycol, with diphenyl carbonate and phosgene.

Among the active hydrogen-containing compounds, the second low-molecular weight compound is a compound which has at least two active hydrogens per one molecule and has a number average molecular weight of less than 300, and examples thereof include, but are not limited to, glycol components used as raw materials of the polyester polyol; polyhydroxy compounds such as glycerin, trimethylolethane, trimethylolpropane, sorbitol, and pentaerythritol; and amine compounds such as ethylenediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, 1,4-cyclohexanediamine, 1,2-propanediamine, hydazine, diethylenetriamine, and triethylenetetramine.

The second urethane prepolymer may further include a hydrophilic group. The term “hydrophilic group,” as used herein, refers to an anionic group (for example, carboxyl group, sulfonic acid group, or phosphoric acid group), or a cationic group (for example, tertiary amino group, or quaternary amino group), or a nonionic hydrophilic group (for example, a group composed of a repeating unit of ethylene oxide, or a group composed of a repeating unit of ethylene oxide and a repeating unit of another alkylene oxide).

Among hydrophilic groups, a nonionic hydrophilic group having a repeating unit of ethylene oxide may, for example, be preferred because the finally obtained polyurethane emulsion has excellent compatibility with other kinds of emulsions. Introduction of a carboxyl group and/or a sulfonic acid group is effective to make the particle size finer.

The ionic group refers to a functional group capable of serving as a hydrophilic ionic group which contributes to self dispersibility in water by neutralization, providing colloidal stability during the processing against agglomeration; stability during shipping, storage and formulation with other additives. These hydrophilic groups could also introduce application specific properties such as adhesion.

When the ionic group is an anionic group, the neutralizer used for neutralization includes, for example, nonvolatile bases such as sodium hydroxide and potassium hydroxide; and volatile bases such as tertiary amines (for example trimethylamine, triethylamine, dimethylethanolamine, methyldiethanolamine, and triethanolamine) and ammonia can be used.

When the ionic group is a cationic group, usable neutralizer includes, for example, inorganic acids such as hydrochloric acid, sulfuric acid, and nitric acid; and organic acids such as formic acid and acetic acid.

Neutralization may be conducted before, during or after the polymerization of the compound having an ionic group. Alternatively, neutralization may be conducted during or after the polyurethane polymerization reaction.

To introduce a hydrophilic group in the second polyurethane prepolymer, a compound, which has at least one active hydrogen atom per one molecule and also has the above hydrophilic group, may be used as an active hydrogen-containing compound. Examples of the compound, which has at least one active hydrogen atom per one molecule and also has the above hydrophilic group, include:

(1) sulfonic acid group-containing compounds such as 2-oxyethanesulfonic acid, phenolsulfonic acid, sulfobenzoic acid, sulfosuccinic acid, 5-sulfoisophthalic acid, sulfanilic acid, 1,3-phenylenediamine-4,6-disulfonic acid, and 2,4-diaminotoluene-5-sulfonic acid, and derivatives thereof, or polyester polyols obtained by copolymerizing them;

(2) carboxylic acid-containing compounds such as 2,2-dimethylolpropionic acid, 2,2-dimethylolbutyric acid, 2,2-dimethylolvaleric acid, dioxymaleic acid, 2,6-dioxybenzoic acid, and 3,4-diaminobenzoic acid, and derivatives thereof, or polyester polyols obtained by copolymerizing them; tertiary amino group-containing compounds such as methyldiethanolamine, butyldiethanolamine, and alkyldiisopropanolamine, and derivatives thereof, or polyester polyol or polyether polyol obtained by copolymerizing them;

(3) reaction products of the above tertiary amino group-containing compounds, or derivatives thereof, or polyester polyols or polyether polyols obtained by copolymerizing them, with quaternizing agents such as methyl chloride, methyl bromide, dimethylsulfuric acid, diethylsulfuric acid, benzyl chloride, benzyl bromide, ethylenechlorohydrin, ethylenebromohydrin, epichlorohydrin, and bromobutane;

(4) nonionic group-containing compounds such as polyoxyethylene glycol or polyoxyethylene-polyoxypropylene copolymer glycol, which has at least 30% by weight of a repeating unit of ethylene oxide and at least one active hydrogen in the polymer and also has a molecular weight of 300 to 20,000, polyoxyethylene-polyoxybutylene copolymer glycol, polyoxyethylene-polyoxyalkylene copolymer glycol, and monoalkyl ether thereof, or polyester-polyether polyols obtained by copolymerizing them; and

(5) combinations thereof.

The term “low solid content polyurethane dispersion,” as used herein, refers to a polyurethane dispersion that contains less than 60 percent by weight of polyurethane particles based on the total weight of the polyurethane dispersion. All individual values and subranges in the range of less than 60 weight percent are included herein and disclosed herein; for example, less than 50 weight percent; or in the alternative, less than 40 weight percent. The low solid content polyurethane dispersion may have a volume average particle size diameter; for example, the low solid content polyurethane dispersion may have a volume average particle size diameter in the range of 0.04 to 5.0 micron. All individual values and subranges from 0.04 to 5.0 micron are included herein and disclosed herein; for example, the low solid content polyurethane dispersion may have a volume average particle size diameter in the range of 0.07 to 1.0 micron; or in the alternative, the low solid content polyurethane dispersion may have a volume average particle size diameter in the range of 0.08 to 0.2 micron. The low solid content polyurethane dispersion may have any polydispersity; for example, the low solid content polyurethane dispersion may have a polydispersity in the range of 1 to 20. All individual values and subranges from 1 to 20 are included herein and disclosed herein; for example, the low solid content polyurethane dispersion may have a polydispersity in the range of 1 to 10; or in the alternative, the low solid content polyurethane dispersion may have polydispersity in the range of 1 to 2. Any conventional method may be employed to make such low solid content polyurethane dispersion.

The term “seed latex,” as used herein refers to dispersions, suspensions, emulsions, or latexes of polyolefins such polyethylene and polypropylene, epoxies, silicon, styrene, acrylate, butadiene, isoprene, vinyl acetate, or copolymers thereof. The term “seed latex,” as used herein, may, for example, further refer to emulsions of polyvinyl acetate, polyethylene-vinyl acetate, polyacrylic, or polyacrylic-styrenic; latexes of polystyrene-butadiene, polyacrylonitrile-butadiene, or polyacrylic-butadiene; aqueous dispersions of polyethylene and polyolefin ionomers; or various aqueous dispersions of polyurethane, polyester, polyamide, epoxy resin, copolymers thereof, or alloys thereof. The seed latex may have any volume average particle size diameter; for example, the seed latex may have a volume average particle size diameter in the range of 0.05 to 5.0 micron. All individual values and subranges from 0.05 to 5.0 micron are included herein and disclosed herein; for example, the seed latex may have a volume average particle size diameter in the range of 0.07 to 1.0 micron; or in the alternative, the seed latex may have a volume average particle size diameter in the range of 0.08 to 0.2 micron. The seed latex may have a bimodal or multimodal particle size distribution. The seed latex may have any polydispersity; for example, the seed latex may have a polydispersity in the range of 1 to 20. All individual values and subranges from 1 to 20 are included herein and disclosed herein; for example, seed latex may have a polydispersity in the range of 1 to 10; or in the alternative, the seed latex may have a polydispersity in the range of to 2. Any conventional method may be employed to make such dispersions, suspension, emulsions, or latexes. Such conventional methods include, but are not limited to, emulsion polymerization, suspension polymerization, micro-emulsion, mini-emulsion, or dispersion polymerization.

The term “surfactants,” as used herein, refers to any compound that reduces surface tension when dissolved in water or water solutions, or that reduces interfacial tension between two liquids, or between a liquid and a solid. Surfactants useful for preparing a stable dispersion in the practice of the present invention may be cationic surfactants, anionic surfactants, zwitterionic, or a non-ionic surfactants. Examples of anionic surfactants include, but are not limited to, sulfonates, carboxylates, and phosphates. Examples of cationic surfactants include, but are not limited to, quaternary amines. Examples of non-ionic surfactants include, but are not limited to, block copolymers containing ethylene oxide and silicone surfactants, such as ethoxylated alcohol, ethoxylated fatty acid, sorbitan derivative, lanolin derivative, ethoxylated nonyl phenol or alkoxylated polysiloxane. Furthermore, the surfactants can be either external surfactants or internal surfactants. External surfactants are surfactants which do not become chemically reacted into the polymer during dispersion preparation. Examples of external surfactants useful herein include, but are not limited to, salts of dodecyl benzene sulfonic acid, and lauryl sulfonic acid salt. Internal surfactants are surfactants which do become chemically reacted into the polymer during dispersion preparation. Examples of an internal surfactant useful herein include, but are not limited to, 2,2-dimethylol propionic acid and its salts, quaternized ammonium salts, and hydrophilic species, such polyethylene oxide polyols.

Polyurethane prepolymers are typically chain extended via a chain extender. Any chain extender known to be useful to those of ordinary skill in the art of preparing polyurethanes can be used with the present invention. Such chain extenders typically have a molecular weight of 30 to 500 and have at least two active hydrogen containing groups. Polyamines are a preferred class of chain extenders. Other materials, particularly water, can function to extend chain length and so are chain extenders for purposes of the present invention. It is particularly preferred that the chain extender is water or a mixture of water and an amine such as, for example, aminated polypropylene glycols such as Jeffamine D-400 from Huntsman Chemical Company, amino ethyl piperazine, 2-methyl piperazine, 1,5-diamino-3-methyl-pentane, isophorone diamine, ethylene diamine, diethylene triamine, triethylene tetramine, triethylene pentamine, ethanol amine, lysine in any of its stereoisomeric forms and salts thereof, hexane diamine, hydrazine and piperazine. In the practice of the present invention, the chain extender may be used as a solution of chain extender in water.

Examples of the chain extender used in the present invention include water; diamines such as ethylenediamine, 1,2-propanediamine, 1,6-hexamethylenediamine, piperazine, 2-methylpiperazine, 2,5-dimethylpiperazine, isophoronediamine, 4,4′-dicyclohexylmethanediamine, 3,3′-dimethyl-4,4′-dicyclohexylmethanediamine, 1,2-cyclohexanediamine, 1,4-cyclohexanediamine, aminoethylethanolamine, aminopropylethanolamine, aminohexylethanolamine, aminoethylpropanolamine, aminopropylpropanolamine, and aminohexylpropanolamine; polyamines such as diethylenetriamine, dipropylenetriamine, and triethylenetetramine; hydrazines; acid hydrazides. These chain extenders can be used alone or in combination.

The ultra high-said content polyurethane dispersion maybe produced via continues method; or in the alternative, it maybe produced via batch process.

In production of the ultra high-said content polyurethane dispersion, the method for producing such ultra high-solid content polyurethane dispersion suitable for sealant applications includes the following steps: (1) providing a first stream, wherein the first stream comprising a first polyurethane prepolymer comprising the reaction product of a natural oil based polyol and polyisocyanate; (2) providing a second stream, wherein the second stream being a media phase selected from the group consisting of a second polyurethane prepolymer, a second polyurethane prepolymer emulsion, a polyurethane dispersion, a seed latex emulsion, or combinations thereof; (3) continuously merging the first stream with the second stream optionally in the presence of a chain extender; and (4) thereby forming a polyurethane dispersion having a solid content of at least 60 percent by weight of the solid contents, preferably 65 percent by weight of solid contents, based on the total weight of the ultra-high solid content polyurethane dispersion, and a viscosity in the range of less than 5000 cps at 20 rpm at 21° C. using spindle #4 with Brookfield viscometer.

In an alternative production of the ultra high-said content polyurethane dispersion, the method for producing such high-solid content polyurethane dispersion suitable for sealant applications includes the following steps: (1) providing a first stream, wherein the first stream being a first polyurethane prepolymer comprising the reaction product of a natural oil based polyol and polyisocyanate; (2) providing a second stream, wherein the second stream being a media phase; (3) continuously merging the first and the second stream together optionally in the presence of a surfactant at a temperature in the range of 10° C. to 70° C., wherein the ratio of the first stream to the second stream being in the range of 0.1 to 0.6, and wherein the surfactant is optionally present in a concentration range of 0.1 to 3.0 percent, based on the total weight of the first stream, the second stream, and the surfactant; (4) thereby forming the ultra-high solid content polyurethane dispersion, wherein the ultra-high solid content polyurethane dispersion having at least a solid content of at least 60 percent by weight of said solid, preferably 65 percent by weight of solid contents, based on the total weight of the ultra-high solid content polyurethane dispersion, and a viscosity in the range of less than 5000 cps at 20 rpm at 21° C. using spindle #4 with Brookfield viscometer.

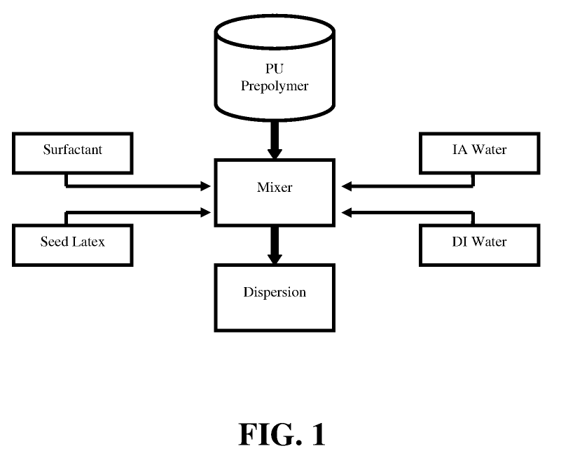

Referring to FIG. 1, a first stream comprising a first polyurethane prepolymer, optionally a surfactant, and optionally water is fed into a mixer, for example an OAKS Mixer or an IKA Mixer or those mixers disclosed in the U.S. Patent Application Ser. No. 60/875.657 filed on Dec. 19, 2006, incorporated herein by reference in its entirety, while a second stream comprising a media phase selected from the group consisting of a second polyurethane prepolymer, a second polyurethane prepolymer emulsion, a polyurethane dispersion, a seed latex emulsion, and/or combinations thereof is fed into the mixer. First stream and second stream are merged together optionally in the presence of a chain extender, dilution water, and/or combinations thereof. The first stream is emulsified into the second stream via high shear rate mixing thereby forming the ultra-high solid content polyurethane dispersion suitable for sealant applications of the instant invention.

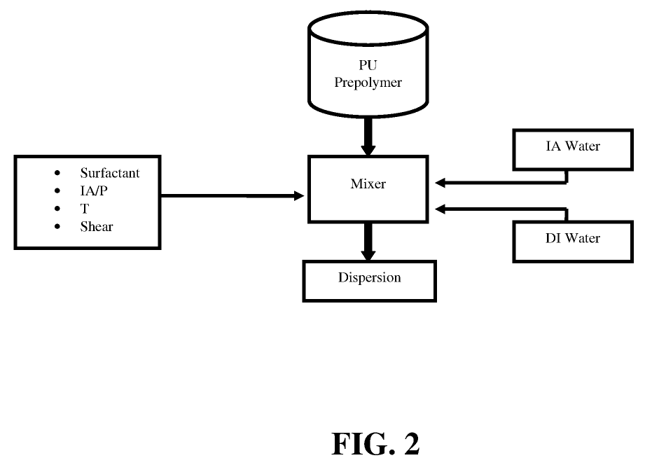

Referring to FIG. 2 a first stream comprising a first polyurethane prepolymer comprising the reaction product of a natural oil based polyol and polyisocyanate, a surfactant, and water is fed into a mixer, for example an OAKS mixer or an IKA mixer or those mixers disclosed in the U.S. Patent Application Ser. No. 60/875.657 filed on Dec. 19, 2006, incorporated herein by reference in its entirety, at a temperature in the range of 10° C. to 70° C., a first polyurethane prepolymer to water weight ratio in the range of about 0.3 to 0.5. Sufficient shear rate is provided to facilitate the formation of the ultra-high solid content polyurethane dispersion of the instant invention. Optionally a chain extender, dilution water, and/or combinations thereof may further be fed into the mixer, and merged with the first stream thereby forming the ultra-high solid content polyurethane dispersion suitable for sealant applications of the instant invention.

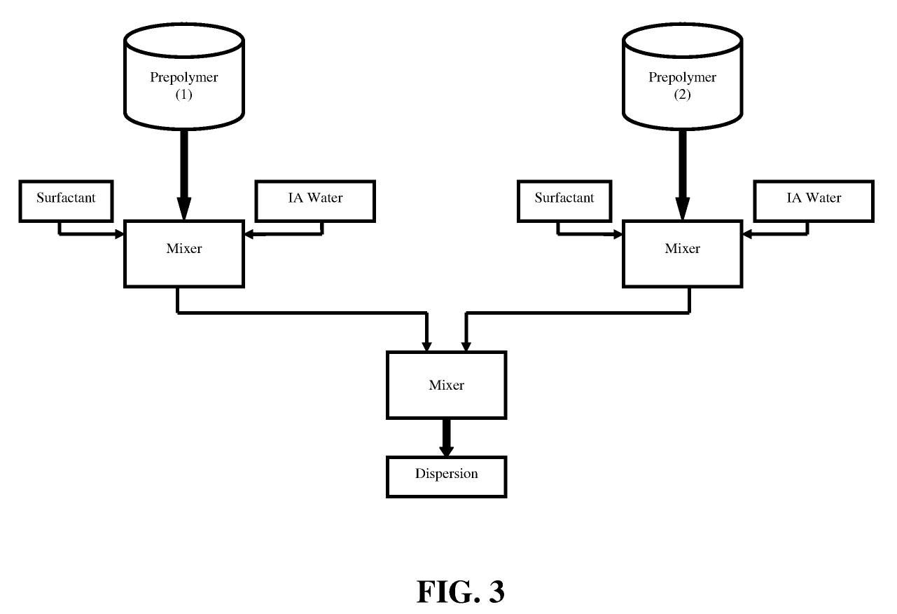

Referring to FIG. 3, a first polyurethane prepolymer comprising the reaction product of a natural oil based polyol and polyisocyanate, optionally a surfactant, and optionally water are fed into a first mixer, for example an OAKS Mixer or an IKA Mixer or those mixers disclosed in the U.S. Patent Application Ser. No. 60/875.657 filed on Dec. 19, 2006, incorporated herein by reference in its entirety, thereby forming a first stream, that is first polyurethane prepolymer or a first polyurethane prepolymer emulsion. A second polyurethane prepolymer, optionally a surfactant, and optionally water are fed into a second mixer, for example an OAKS Mixer or an IKA Mixer or those mixers disclosed in the U.S. Patent Application Ser. No. 60/875.657 filed on Dec. 19, 2006, incorporated herein by reference in its entirety, thereby forming a second stream, that is a second polyurethane prepolymer or a second polyurethane prepolymer emulsion. The first stream and second streams are fed into a third mixer, for example an OAKS Mixer or an IKA Mixer or those mixers disclosed in the U.S. Patent Application Ser. No. 60/875.657 filed on Dec. 19, 2006, incorporated herein by reference in its entirety, and merged together optionally in the presence of a chain extender, dilution water, or combinations thereof thereby forming the ultra-high solid content polyurethane dispersion suitable for sealant applications of the instant invention.

In production, the sealant composition may be produced via any number of mixing devices. One such device may be a vertical mixing vessel with dual shafts, first shaft comprising a sweep blade and the second shaft comprising a high speed disperser. An ultra-high solid polyurethane dispersion may be added into the vessel. At this time the sweep blade may be started, and subsequently surfactant, thickener, dispersant, freeze-thaw agents, and additive such as a propylene glycol, and plasticizer may be added to the vessel. Once enough material has been added to the vessel such that the high speed disperser blade is covered, then this blade may be started. To this mixture pigments such as titanium dioxide and fillers such as calcium carbonate may be added while maintaining the sweep blade and high speed disperser turned on. Finally, a neutralizing agent such as ammonia may be added to the vessel. Mixing should continue at, for example, 25° C. until the mixture is thoroughly mixed. The mixture may or may not be vacuumed. Vacuuming of the mixture can occur in any suitable container either in the mixer or outside of the mixer.

### EXAMPLES

The present invention will now be explained in further detail by showing Inventive Examples, and Comparative Examples, but the scope of the present invention is not, of course, limited to these Examples.

### First Polyurethane Prepolymer Synthesis

A first polyurethane prepolymer was prepared using 24.7 g of Polyol A (a polyol having a molecular weight of 2000 g/mole, which was based on sunflower oil and obtained from The Dow ChemicalCompany; 56.4 g of Polyol B (a polyol having a molecular weight of 3800 g/mole and 2.2 functionality based on the condensation product of Terathane 650 TN, a polytetramethyleneglycol based diol, which was obtained from DuPont, and hydroxymethyl stearate (HMS) monomer derived from vegetable oil, obtained from Dow Chemical; 13.9 g of Isophorone diisocyanate (IPDI), 3.5 g of Carbowax E1000, which is a 1000 molecular weight polyoxyethylene diol, and 1.5 g of MPEG 950, which was prepared by ethoxylation of methanol to 950 molecular weight in a reactor in the presence of 0.01 weight percent dibutyltindilaurate catalyst. The mixture was reacted at 70° C. for 2 hours after being thoroughly mixed. The final NCO level was 2.5 weight percent.

### Seed Latex Formulations

Two acrylate latexes having different amounts of solids were employed to prepare the inventive and comparative examples. The first acrylate latex was UCAR 1635 comprising 58.0 percent by weight of solid based on the total weight of the acrylate latex. The second acrylate latex was UCAR 169S comprising 62.0 percent by weight of solid based on the total weight of the acrylate latex.

### Seed Polyurethane Latex

The first prepolymer prepared above is emulsified using a high shear mixer continuously. In this process, 120 g of prepolymer is fed into a high shear mixer where it is blended with 8.63 g of aqueous solution of anionic surfactant, that is sodium dodecylbenzene sulfonate (2.0 weight percent, based on the weight of the prepolymer), and 56 g of de-ionized water. The pre-emulsion is subsequently chain extended with 15.9 g aqueous solution of ethylene diamine chain extender (10 percent solution in water) at 95 percent stoichiometric ratio to NCO level. The final seed polyurethane dispersion comprises 61 percent by weight of solids, excluding any fillers.

### Preparation of the First Ultra-High Solid Polyurethane/Acrylate Dispersion (First PU/Acrylate Hybrid Dispersion)

70 grams of the first polyurethane prepolymer was fed into a high shear mixing device where it was emulsified into 200 grams of an acrylate latex, UCAR 169S (comprising 61.3 percent by weight of solid based on the total weight of the acrylate latex; available from The Dow Chemical Company). The resulting ultra-high solid content polyurethane/acrylic hybrid dispersion had a bimodal particle size and a very broad particle size distribution. It had approximately 72.5 percent by weight of solid particles, excluding the weight of any filler, based on the total weight of the dispersion. The final ratio of urethane to acrylate was 70:30.

### Second Polyurethane Prepolymer Synthesis

A second polyurethane prepolymer was prepared using 39.6 g of Polyol A (a polyol having a molecular weight of 2000 g/mole, which was based on sunflower oil and obtained from The Dow ChemicalCompany; 39.6 g of Polyol B (a polyol having a molecular weight of 3800 g/mole and 2.2 functionality based on the condensation product of Terathane 650 TN, a polytetramethyleneglycol based diol, which was obtained from DuPont, and hydroxymethyl stearate (HMS) monomer, obtained from Dow Chemical; 15.8 g of Isophorone diisocyanate (IPDI), 3.5 g of Carbowax E1000, which is a 1000 molecular weight polyoxyethylene diol, and 1.5 g of MPEG 950, which was prepared by ethoxylation of methanol to 950 molecular weight in a reactor in the presence of 0.01 weight percent dibutyltindilaurate catalyst. The mixture was reacted at 70° C. for 2 hours after being thoroughly mixed. The final NCO level was 3.0 weight percent.

### Preparation of the Second Ultra-High Solid Polyurethane/Acrylate Dispersion (Second PU/Acrylate Hybrid Dispersion)

70 grams of the first polyurethane prepolymer was fed into a high shear mixing device where it was emulsified into 200 grams of an acrylate latex, UCAR 169S (comprising 61.3 percent by weight of solid based on the total weight of the acrylate latex; available from The Dow Chemical Company). The pre-emulsion was then chain extended with 4.6 g of 10 EDA solution. The resulting ultra-high solid content polyurethane/acrylic hybrid dispersion had a bimodal particle size and a very broad particle size distribution. It had approximately 71.7 percent by weight of solid particles, excluding the weight of any filler, based on the total weight of the dispersion. The final ratio of urethane to acrylate was 70:30.

### Inventive Sealant Composition 1-4

Inventive sealant compositions 1-4 were prepared according to the following procedure. The formulation components for each inventive sealant composition are listed in Table I. A brass jig with an opening in the middle with interior dimension of 1.5 inches by 5.0 inches and 0.25 inches thick was used. The jig was placed on a sheet of release paper and the formulation components were placed in the jig and struck flush with a putty knife The jig was removed and the films were allowed to dry for 13 days at approximately 25° C. The height of the film was measured using a micrometer that reads in inches to three decimal places. Three readings were taken down at the center of the film from top to bottom, and an average was reported. The release paper has a thickness of 0.005 inches, and was deducted from the film reading. The percent change in height from 0.25 inches was reported as the percent shrinkage. The following formula was used to calculate percent shrinkage:

Percent Shrinkage=100*(initial height−cured height)/initial height

The resultant inventive sealant compositions were further tested for their properties, and those properties and results are shown in Table II.

### Comparative Examples A-D

Comparative Examples A-D were prepared according to the following procedures. The formulation components for each comparative sealant composition are listed in Table I. A brass jig with an opening in the middle with interior dimension of 1.5 inches by 5.0 inches and 0.25 inches thick was used. The jig was placed on a sheet of release paper and the formulation components were placed in the jig and struck flush with a putty knife The jig was removed and the films were allowed to dry for 13 days at approximately 25° C. The height of the film was measured using a micrometer that reads in inches to three decimal places. Three readings were taken down at the center of the film from top to bottom, and an average was reported. The release paper has a thickness of 0.005 inches, and was deducted from the film reading. The percent change in height from 0.25 inches was reported as the percent shrinkage. The following formula was used to calculate percent shrinkage:

Percent Shrinkage=100*(initial height−cured height)/initial height

The resultant comparative sealant compositions were further tested for their properties, and those properties and results are shown in Table II.

The present invention may be embodied in other forms without departing from the spirit and the essential attributes thereof, and, accordingly, reference should be made to the appended claims, rather than to the foregoing specification, as indicating the scope of the invention.

### Test Methods

Test methods include the following:

Volume average particle size diameter and particle size distribution were measured via Dynamic Light Scattering (Coulter LS 230).

Viscosity was measured via Brookfield viscometer.

Isocyanate content (% NCO) was determined using a Meter Toledo DL58.

Low temperature flexibility (joint movement flexibility) was determined according to ASTM C-793, Standard Test Method for Effects of Accelerated Weathering on Elastomeric Joint Sealants.

Elastic recovery and elongation flexibility was determined according to the following procedure. Thin films were prepared on Teflon surface using a 20 mil draw down device. The films were dried for 7 days at room temperature before testing. The ultra-high solid polyurethane dispersions and hybrid dispersions were poured into a Petri dish with PTFE liner and allowed to dry at ambient condition for 7 day. The resultant films had a thickness in the range of 10 to 20 mils. Microtensile specimens (ASTM-D 1708) were cut from the films for tensile testing using an Instron 5581 mechanical testing system. For tensile stress-strain characterization, the specimens were loaded at 100%/min (22.25 mm/min) until break. Stress-strain curves, secant modulus at 100%, elongation at break, and tensile strength were recorded. At least three specimens were used per each sample. For recovery characterization, the specimens were drawn to 100% and then returned to 0%, which is referred to as one cycle. The cycle was repeated 10 times continuously for one test. Both tensile and recovery tests were performed at room temperature, 0° C., and −25° C. The 10^{th} cycle recovery was calculated to be 100% minus the initial strain at the beginning of the 10^{th} cycle. The low temperature test was performed within a BEMCO Environment Chamber using a WATLOW 942 temperature controller with liquid nitrogen as the coolant. An additional thermal couple was placed close to the specimen to monitor the actual temperature.

Shrinkage was determined according to the following procedure. A brass jig with an opening in the middle with interior dimension of 1.5 inches by 5.0 inches and 0.25 inches thick was used. The jig was placed on a sheet of release paper and the formulation components were placed in the jig and struck flush with a putty knife The jig was removed and the films were allowed to dry for 13 days at approximately 25° C. The height of the film was measured using a micrometer that reads in inches to three decimal places. Three readings were taken down at the center of the film from top to bottom, and an average was reported. The release paper has a thickness of 0.005 inches, and was deducted from the film reading. The percent change in height from 0.25 inches was reported as the percent shrinkage. The following formula was used to calculate percent shrinkage:

Percent Shrinkage=100*(initial height−cured height)/initial height

TABLE I

| | Inventive | Inventive | Comparative | Comparative |
|---|---|---|---|---|
| | Sealant | Sealant | Sealant | Sealant |
| | Formulation 1 | Formulation 2 | Formulation A | Formulation B |
| | (Clear) | (Clear) | (Clear) | (Clear) |
| Dispersion | First | Second | UCAR 169S | UCAR 163S |
| Component | PU/Acrylate | PU/Acrylate | | |
| | Hybrid | Hybrid | | |
| | Dispersion | Dispersion | | |
| Dispersion | (60 wt %) | (60 wt %) | (60 wt %) | (60 wt %) |
| Triton X- | 0.6 wt % | 0.6 wt % | 0.6 wt % | 0.6 wt % |
| 405 | | | | |
| Tinuvin 327 | 0.3409 wt % | 0.3372 wt % | 0.2918 wt % | 0.2731 wt % |
| Tinuvin 770 | 0.3409 wt % | 0.3372 wt % | 0.2918 wt % | 0.2731 wt % |
| DF | | | | |
| UCAR | 3.0 wt % | 3.0 wt % | 3.0 wt % | 3.0 wt % |
| Polyphobe | | | | |
| 106HE | | | | |
| Dynasylan 6598 | 0.4 wt % | 0.4 wt % | 0.4 wt % | 0.4 wt % |
| Tamol 850 | — | — | — | — |
| Ti-Pure R-902 | — | — | — | — |
| Drikalite | — | — | — | |
| Propylene Glycol | 0.8 wt % | 0.8 wt % | 0.8 wt % | 0.8 wt % |
| Jayflex 77 | — | — | — | — |
| Cellosize | — | — | — | — |
| QP-100MH | | | | |
| Aqueous | 0.48 wt % | 0.48 wt % | 0.48 wt % | 0.48 wt % |
| Ammonia (28%) | | | | |
| Dispersion | 34.04 wt % | 34.05 wt % | 34.14 wt % | 34.17 wt % |
| Pigment:Base | — | — | — | — |
| polymer | | | | |
| | Inventive | Inventive | Comparative | Comparative |
| | Sealant | Sealant | Sealant | Sealant |
| | Formulation 1 | Formulation 2 | Formulation C | Formulation D |
| | (Pigmented) | (Pigmented) | (Pigmented) | (Pigmented) |
| Dispersion | First | Second | UCAR 169S | UCAR 163S |
| Component | PU/Acrylate | PU/Acrylate | | |
| | Hybrid | Hybrid | | |
| | Dispersion | Dispersion | | |
| Dispersion | (22 wt %) | (22 wt %) | (22 wt %) | (22 wt %) |
| Triton X- | 0.42 wt % | 0.42 wt % | 0.42 wt % | 0.42 wt % |
| 405 | | | | |
| Tinuvin 327 | 0.1684 wt % | 0.1675 wt % | 0.1558 wt % | 0.1505 wt % |
| Tinuvin 770 | 0.1684 wt % | 0.1675 wt % | 0.1558 wt % | 0.1505 wt % |
| DF | | | | |
| UCAR | — | — | — | — |
| Polyphobe | | | | |
| 106HE | | | | |
| Dynasylan 6598 | 0.4 wt % | 0.4 wt % | 0.4 wt % | 0.4 wt % |
| Tamol 850 | 0.4 wt % | 0.4 wt % | 0.4 wt % | |
| Ti-Pure R-902 | 1.3 wt % | 1.3 wt % | 1.3 wt % | 1.3 wt % |
| Drikalite | 49.2 wt % | 48.9 wt % | 45.4 wt % | 43.8 wt % |
| Propylene Glycol | 0.8 wt % | 0.8 wt % | 0.8 wt % | 0.8 wt % |
| Jayflex 77 | — | — | — | — |
| Cellosize | 0.6 wt % | 0.6 wt % | 0.6 wt % | 0.6 wt % |
| QP-100MH | | | | |
| Aqueous | 0.06 wt % | 0.06 wt % | 0.06 wt % | 0.06 wt % |
| Ammonia (28%) | | | | |
| Dispersion | 24.46 wt % | 24.73 wt % | 28.26 wt % | 29.88 wt % |
| Pigment:Base | 1:5 | 1:5 | 1:5 | 1:5 |
| polymer | | | | |

TABLE II

| | Inventive | Inventive | Comparative | Comparative | Inventive | Inventive | Comparative | Comparative |
|---|---|---|---|---|---|---|---|---|
| | Sealant | Sealant | Sealant | Sealant | Sealant | Sealant | Sealant | Sealant |
| | Formulation 1 | Formulation 2 | Formulation A | Formulation B | Formulation 1 | Formulation 2 | Formulation C | Formulation D |
| | (Clear) | (Clear) | (Clear) | (Clear) | (Pigmented) | (Pigmented) | (Pigmented) | (Pigmented) |
| Solid content | 72.5 | 71.7 | 58.0 | 62.0 | 72.5 | 71.7 | 58.0 | 62.0 |
| of the Ultra- | | | | | | | | |
| High Solid | | | | | | | | |
| Polyurethane | | | | | | | | |
| Dispersion | | | | | | | | |
| Elongation | 562 | — | brittle | — | — | — | — | — |
| Flexibility | | | | | | | | |
| (%) @ | | | | | | | | |
| −25° C. | | | | | | | | |
| Recovery | 72 | — | No recovery | — | — | — | — | — |
| (%) @ −25° C. | | | | | | | | |
| Joint | Pass | — | Fail | — | — | — | — | — |
| Movement | | | | | | | | |
| Flexibility | | | | | | | | |
| −25° C. | | | | | | | | |
| Shrinkage (%) | 31.27 | 32.06 | 41.74 | — | 21.57 | 22.21 | 30.28 | — |
| T_{g} (° C.) | −54.9 | — | −4 | — | — | — | — | — |
| | and −21.5 | | | | | | | |

We claim:

1. A sealant composition comprising:
an ultra-high solid polyurethane dispersion comprising:
a first component, wherein said first component comprising a first polyurethane prepolymer comprising the reaction product of a natural oil based polyol and polyisocyanate;
a second component, wherein said second component comprising a media phase selected from the group consisting of a second polyurethane prepolymer emulsion, a low solid content polyurethane dispersion, a seed latex, and combinations thereof; and
optionally a chain extender;
wherein said ultra-high solid polyurethane dispersion having at least a solid content of 60 percent or greater by weight of solid content, based on the total weight of said ultra-high solid polyurethane dispersion, and a viscosity of less than 5000 cps at 20 rpm at 21° C. using spindle #4 with Brookfield viscometer.

2. The sealant composition according to claim 1, wherein said sealant composition further comprises one or more surfactants, one or more dispersants, one or more thickeners, one or more pigments, one or more fillers, one or more freeze-thaw agent, one or more neutralizing agents, one or more plasticizers, one or more antioxidants, one or more UV stabilizers, and/or combinations thereof.

3. The sealant composition according to claim 2, wherein said sealant composition comprises 25 to less than 100 percent by weight of said ultra-high solid polyurethane dispersion, based on the weight of the sealant composition.

4. The sealant composition according to claim 2, wherein said sealant composition comprises 0.1 to 5 percent by weight of said one or more surfactants, 0.1 to 5 percent by weight of said one or more dispersants, 0.1 to 5 percent by weight of said one or more thickeners, 0 to less than 10 percent by weight of said one or more pigments, 0 to 75 percent by weight of said one or more fillers, 0.1 to 2 percent by weight of said one or more freeze-thaw agents, 0.1 to 1 percent by weight of said one or more neutralizing agents, 0 to 12 percent by weight of said one or more plasticizers, 35 to 50 percent by weight of one or more fillers, or any two or more combinations thereof.

5. The sealant composition according to claim 2, wherein said sealant composition further comprising 0.1 to less than 10 percent by weight of one or more pigments, and wherein said sealant composition has an elongation flexibility of at least 650 percent at −25° C.

6. The sealant composition according to claim 2, wherein said sealant composition is substantially free of any pigments, and wherein said sealant composition has an elongation flexibility in the range of 100 to 600 percent at −25° C.

7. The sealant composition according to claim 2, wherein said sealant composition has an elastic recovery of 50 percent or greater at −25° C.

8. The sealant composition according to claim 2, wherein said sealant composition has a shrinkage of less than 30 percent.

9. The sealant composition according to claim 1, wherein said first component comprises one or more first polymer resins and said second component comprising one or more second polymer resins, and wherein said first polymer resin and said second polymer resin have a volume average particle size ratio in the range of 1:5 to 1:2.

10. The sealant composition according to claim 9, wherein said ultra-high solid content of the polyurethane dispersion comprises 20 to 40 percent by weight of said one or more first polymer resins having a particle size in the range of 0.04 micron to 5.0 micron, and 60 to 80 percent by weight of said one or more second polymer resins having a particle size in the range of 0.05 micron to 5.0 micron, based on the total weight of said one or more first polymer resins and said one or more second polymer resins.

11. The sealant composition according to claim 1, wherein said seed latex is selected from the group consisting of a dispersion, emulsion, or latex of olefins, epoxies, silicone, styrene, acrylate, butadiene, isoprene, vinyl acetate, copolymers thereof, and blends thereof.

12. The sealant composition according to claim 1, wherein said seed latex is an organic polymer suspended in water.

13. The sealant composition according to claim 1, wherein said polyisocyanate is aromatic or aliphatic.

14. The sealant composition according to claim 1, wherein said first polyurethane prepolymer is ionic or non-ionic.

15. The sealant composition according to claim 13, wherein said first polyurethane prepolymer is isocyanate terminated or hydroxyl terminated.
